(19) United States
(12) Patent Application Publication
(10) Pub. No.: US 2007/0025791 A1
(43) Pub. Date: Feb. 1, 2007

(54) Ribbon Cassette Capable of Maintaining Position of Spool

(76) Inventor: Yueh-Cheng Lin, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,060

(22) Filed: Oct. 4, 2005

(30) Foreign Application Priority Data
Aug. 1, 2005 (TW) 094126042

(51) Int. Cl. B41J 17/32

(52) U.S. Cl. 400/208

(57) ABSTRACT

A ribbon cassette capable of maintaining a position of one of its spools includes a shell, two spools, and two fasteners. Each of the fasteners is disposed at one side of one of the two spools for fastening the position of the spool. Therefore the spool is not able to rotate. Accordingly, the ribbon cassette is capable of preventing the spool from unexpected rotation during transportation. Therefore the ribbon is prevented from being driven by the spool. Hence the problem that the ribbon is slackened or is driven to protrude outside the ribbon cassette is solved.

### BACKGROUND OF THE INVENTION

1. Field of the Invention

The present invention relates to a ribbon cassette, and more particularly, to a ribbon cassette capable of maintaining a position of a spool.

2. Description of the Prior Art

During operation of a conventional ribbon cassette, a ribbon spool is easily rotated by bumping, gravity, or other factors. Therefore, the ribbon on the spool is easily unspooled. Moreover, part of the ribbon can end up protruding outside the ribbon cassette. Among conventional ribbon cassettes, the ribbon is also easily shifted by similar factors so that the position of the ribbon deviates from a default position on the spool. When the ribbon is used for printing, the ribbon is transported by rotation of the spool from a supply end to a recycling end. If the ribbon has been shifted, then there can be wrinkles of various sizes on the unspooled part of the ribbon so that the quality of printing is significantly decreased. Moreover, the shifted ribbon also easily contacts or interferes with a ribbon cassette shell so that the shifted ribbon becomes easily jammed inside the shell. Besides, the jammed ribbon is not readily transported by the spool so that the printer cannot operate normally and fails in printing.

FIG. 1 is a diagram of a prior art ribbon cassette 100 and a ribbon 101 wherein the ribbon 101 is neither tilted nor wrinkled. The ribbon cassette 100 comprises a shell 103, a first spool 105, and a second spool 107. The first spool 105 is disposed at a supply end of the shell 103 in a rotatable manner, and the second spool 107 is disposed at a recycling end of the shell 103 in a rotatable manner. The first spool 105 and the second spool 107 are used for transporting the ribbon 101 by rotation. Typically, one end of the ribbon 101 is attached to the second spool 107 by an adhesive tape 109 so that the ribbon 101 wrapped on the second spool 107 can be easily transported by the second spool 107.

FIG. 2 is a diagram of the prior art ribbon cassette 100 and the ribbon 101 wherein the position of the ribbon 101 on the first spool 105 is shifted by external forces so that an unspooled part 1011 of the ribbon 101 is wrinkled. If the ribbon 101 of the prior art ribbon cassette 100 is shifted and wrinkled as shown in FIG. 2, when the ribbon 101 is transported by rotation of the first spool 105 and the second spool 107, the quality of thermal transfer printing is decreased.

FIG. 3 is a diagram of the prior art ribbon cassette 100 and the ribbon 101 wherein the ribbon 101 is shifted and deviates from a default position. When the ribbon 101 is transported by the rotation of the first spool 105 and the second spool 107, the ribbon 101 tends to become more shifted. Not only is the unspooled part 1011 of the ribbon 101 wrinkled, but the ribbon 101 can become jammed inside the shell 103. If the ribbon 101 is transported by the first spool 105 at the supply end of the shell 103, and the ribbon 101 is not able to be transported by the second spool 107 at the recycling end of the shell 103 since the ribbon 101 is jammed, then part of the jammed ribbon 101 is driven to protrude outside the shell 103.

FIG. 4 is a side view of part of the prior art ribbon cassette 100. As shown in FIG. 4, since the ribbon 101 is driven to protrude outside the shell 103 by the rotation of the first spool 105 at the supply end of the shell 103, and since the jammed ribbon 101 is not able to be transported by the second spool 107 at the recycling end of the shell 103, a part 1013 of the ribbon 101 is loose and is driven to protrude outside the shell 103.

The prior art ribbon cassette does prevent the ribbon from becoming wrinkled or unwrapped outside the shell, so that when the ribbon is used for thermal transfer printing, the quality of printing is significantly decreased.

### SUMMARY OF THE INVENTION

Therefore a ribbon cassette capable of maintaining a position of a spool is provided in the present invention to solve the aforementioned problems.

A ribbon cassette capable of maintaining a position of a spool comprises a shell, a first spool disposed on the shell, a second spool disposed on the shell, a first fastener disposed at a first side of the first spool for fixing a relative distance between the first spool and the shell, and a second fastener disposed at a second side of the first spool for fixing a relative distance between the first spool and the shell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art ribbon cassette and a ribbon wherein the ribbon is neither tilted nor wrinkled.

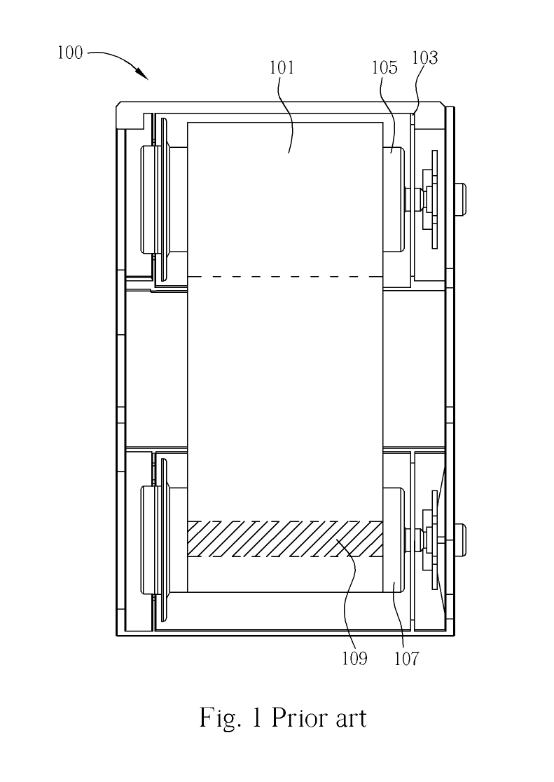

FIG. 2 is a diagram of the prior art ribbon cassette and the ribbon wherein the position of the ribbon on the first spool is shifted by external forces so that an unspooled part of the ribbon is wrinkled.

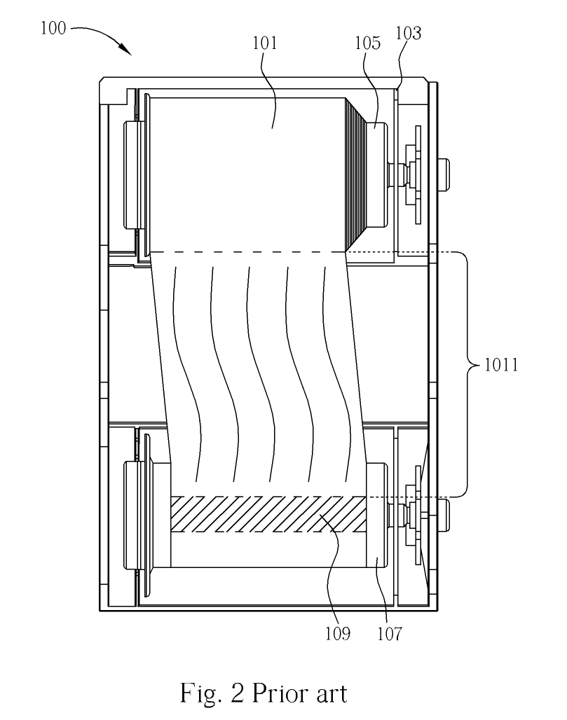

FIG. 3 is a diagram of the prior art ribbon cassette and the ribbon wherein the ribbon is shifted and deviates from a default position.

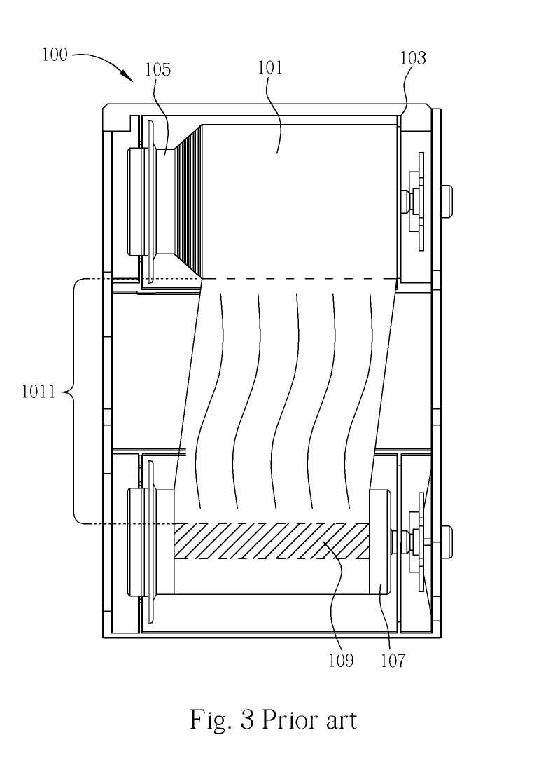

FIG. 4 is a side view of part of the prior art ribbon cassette.

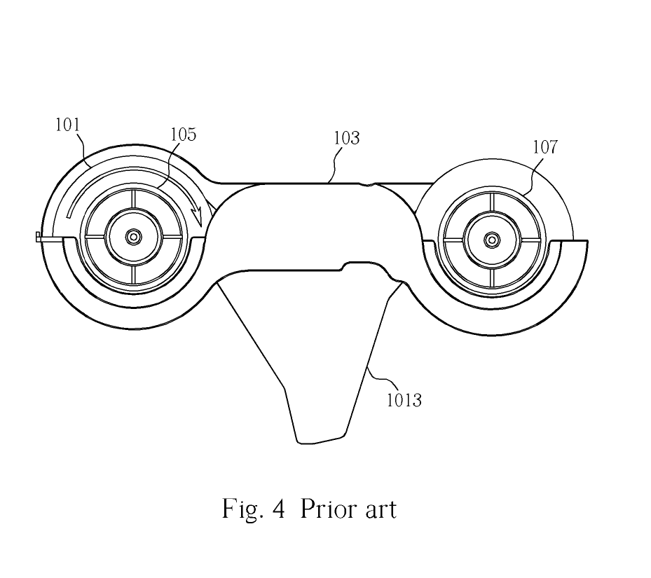

FIG. 5 is a diagram of part of a present invention ribbon cassette having two fasteners, wherein a ribbon is wrapped on a first spool of the present invention ribbon cassette.

FIG. 6 is a front view of the present invention ribbon cassette having both the fasteners disposed thereon.

FIG. 7 is a side view of the ribbon cassette showing the second fastener.

### DETAILED DESCRIPTION

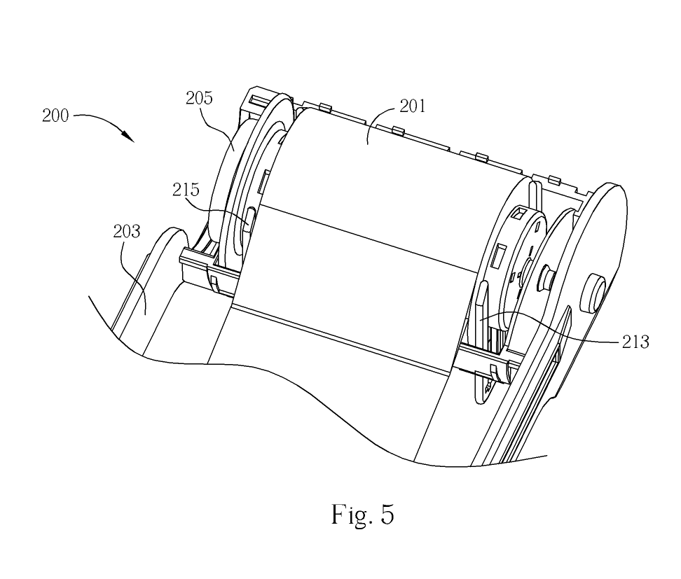

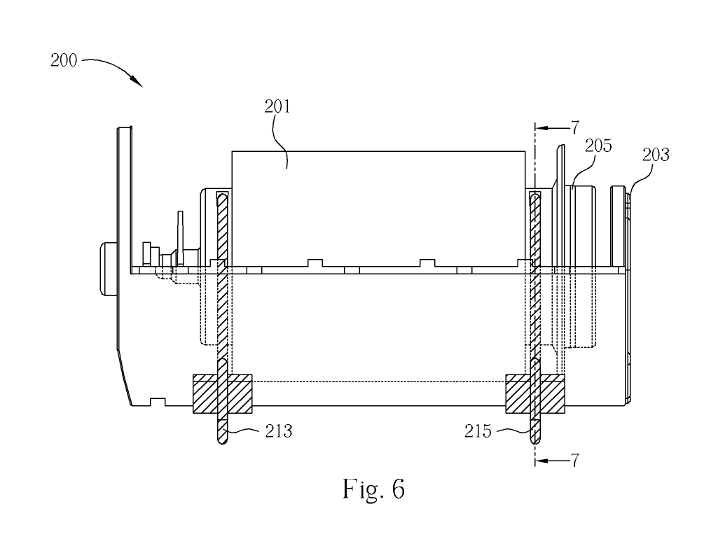

FIG. 5 is a diagram of part of a present invention ribbon cassette 200 having two fasteners 213 and 215, wherein a ribbon 201 is wrapped on a first spool 205 of the ribbon cassette 200. The present invention ribbon cassette 200 comprises a shell 203, the first spool 205, a second spool 207 (not shown), a first detachable fastener 213, and a second detachable fastener 215. Note that only part of the ribbon cassette 200 is shown in FIG. 5 for showing clearly the positions where both the fasteners 213 and 215 are disposed on the ribbon cassette 200. The detailed structure of the present invention ribbon cassette 200 is discussed further with FIG. 6.

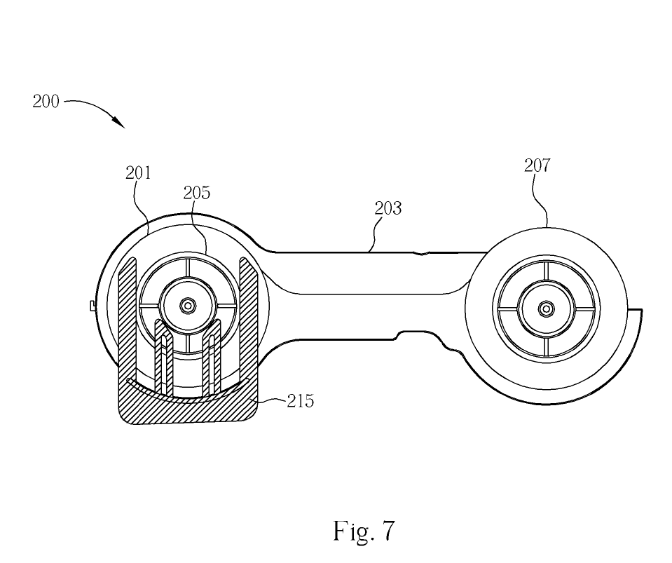

FIG. 6 is a front view of the present invention ribbon cassette 200 having both the fasteners 213 and 215 disposed thereon. The ribbon 201 is wrapped on the first spool 205 and the second spool 207 (not shown) of the ribbon cassette 200. The ribbon 201 is transported by the rotation of the first spool 205 and the second spool 207 of the present invention ribbon cassette 200 during the process of thermal transfer printing. However, as mentioned before, the first spool 205 of the ribbon cassette 200 must be fixed before the process of transportation or printing so that that the ribbon 201 becoming shifted or loose is prevented. Therefore, as shown in FIG. 6, the first fastener 213 and the second fastener 215 are disposed at both sides of the first spool 205 by penetrating both the shell 203 and the first spool 205 so that a relative position between the first spool 205 and the shell 203 is fixed, and the rotation and the movement of the first spool 205 are both fixed. The first fastener 213 and the second fastener 215 can be used for fixing the first spool 205 to the shell 203 since both the fasteners 213 and 215 penetrate both the shell 203 and the first spool 205, so that the first spool 205 is not able to rotate. Compared with the prior art ribbon cassette 100, while being affected by vibrations or other unpredictable factors, the first spool 205 of the present invention ribbon cassette 200 is not rotated nor shifted, and the ribbon 201 wrapped on the first spool 205 is not shifted, not loosened, nor driven to protrude outside the shell 203. In addition, a section line 7 penetrating the second fastener 215 in FIG. 6 is a reference line referenced in FIG. 7.

FIG. 7 is a side view of the ribbon cassette 200 showing the second fastener 215. As shown in FIG. 7, since the second fastener 215 is penetrating both the shell 203 and the first spool 205, the first spool 205 is unable to be shifted or to rotate, and is thus fixed.

In FIG. 6 and FIG. 7, the first fastener 213 and the second fastener 215 are disposed where the first spool 205 is in contact with the ribbon 201. Therefore, in addition to fixing the first spool 205 from moving or rotating with respect to the shell 203, the first fastener 213 and the second fastener 215 are also capable of maintaining the position of the ribbon 201 in a fixed range on the first spool 205. Furthermore, during the process of transportation of the ribbon cassette, an included angle between a spooling direction of the ribbon 201 and the direction of the transportation of the ribbon 201 is also fixed, wherein the spooling direction is from the first spool 205 to the second spool 207. The ribbon 201 so fixed in transportation direction is not easily shifted. An unspooled part of the ribbon 201 is also not easily wrinkled nor jammed by the shell 203. Therefore, the quality of the resulting printing is improved.

For preventing situations such as the first spool rotating with respect to the shell by vibration, gravity, or other factors, and the ribbon being wrinkled, loose, or jammed by the shell, two detachable fasteners are disposed at both sides of the first spool of the present invention ribbon cassette for penetrating both the first spool and the shell. Therefore, the first spool is fixed on the shell and prevented from moving or rotating with respect to the shell so that the ribbon wrapped on the first spool is not driven to be shifted, loosened, or jammed by the shell. The prior art defect that a rotation of the first spool is not able to be prevented in the prior art ribbon cassette during processes other than the printing process is also prevented. Besides, the distances between the fasteners and the ribbon on the first spool can also be increased; the fasteners do not have to be in contact with the ribbon on the first spool in the present invention. Therefore, a spooling direction of the ribbon from the first spool to the second spool is also effectively fixed without both the fasteners pressing the ribbon. Since both the fasteners are not in contact with the ribbon, and when the ribbon is pressed by both the fasteners, there may be wrinkles on the ribbon.

The ribbon is thus not easily shifted unlike in the prior art ribbon cassette. When the spooling direction of the ribbon from the first spool to the second spool is fixed, the ribbon is not easily wrinkled, and the quality of thermal transfer printing is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A ribbon cassette capable of maintaining a position of a spool, comprising:
a shell;
a first spool disposed on the shell;
a second spool disposed on the shell;
a first fastener disposed at a first side of the first spool for fixing a relative distance between the first spool and the shell; and
a second fastener disposed at a second side of the first spool for fixing a relative distance between the first spool and the shell.

2. The ribbon cassette of claim 1, wherein a ribbon is wrapped around the first spool and the second spool.

3. The ribbon cassette of claim 2, wherein the first fastener and the second fastener fasten the position of the ribbon on the first spool.

4. The ribbon cassette of claim 2, wherein the two fasteners are in contact with the ribbon.

5. The ribbon cassette of claim 1, wherein the first fastener and the second fastener prevent the first spool from being rotated.

6. The ribbon transportation device of claim 1, wherein the first side of the first spool and the second side of the first spool are respectively spanned by the first fastener and the second fastener.

7. The ribbon cassette of claim 1, wherein the first side of the first spool and the shell are spanned by the first fastener, and the second side of the first spool and the shell are spanned by the second fastener.

8. The ribbon cassette of claim 1, wherein each fastener is detachably disposed on the first spool.

9. The ribbon cassette of claim 1 being a ribbon cassette of a thermal transfer printer.
